(19) United States
(12) Patent Application Publication
(10) Pub. No.: US 2009/0225834 A1
(43) Pub. Date: Sep. 10, 2009

(54) METHOD AND APPARATUS FOR IMAGE INTRA PREDICTION

(75) Inventors: Hak-sup SONG, Suwon-si (KR); Jung-hye MIN, Yongin-si (KR)

Correspondence Address: SUGHRUE MION, PLLC, 2100 PENNSYLVANIA AVENUE, N.W., SUITE 800, WASHINGTON, DC, 20037, US

(73) Assignee: Samsung Electronics Co., Ltd., Suwon-si (KR)

(21) Appl. No.: 12/398,286

(22) Filed: Mar. 5, 2009

(30) Foreign Application Priority Data
Mar. 5, 2008 (KR) 10-2008-0020586

(51) Int. Cl. H04N 7/26

(52) U.S. Cl. 375/240.12; 375/E07.243

(57) ABSTRACT

A method and apparatus for intra prediction of an image having arbitrary directivity are provided. Arbitrary edge directions and amplitudes of the edges based are calculated on neighboring pixels of a prediction block. From the calculated edge directions, a number of intra prediction directions in an order of the amplitudes of the edges is selected. An optimum intra prediction mode is determined by performing block prediction in the selected number of the intra prediction directions.

### CROSS-REFERENCE TO RELATED PATENT APPLICATIONS

This application claims the priority from Korean Patent Application No. 10-2008-0020586, filed on Mar. 5, 2008, in the Korean Intellectual Property Office, the disclosure of which is incorporated herein in its entirety by reference.

### BACKGROUND OF THE INVENTION

1. Field of the Invention

Methods and apparatuses consistent with the present invention relate to encoding and decoding image data, and more particularly, to image intra prediction.

2. Description of the Related Art

In general, an intra prediction process of H.264/Advanced video coding (AVC) provides a variety of prediction modes for prediction-coding a block in a frame by using only information in the identical frame. The prediction process performs an important role in increasing compression efficiency of the H.264/AVC. However, there is a problem that an encoder should select one mode, which has the best compression efficiency, from among the modes. In order to select an optimum intra prediction mode, encoding of all determined intra prediction directions is performed, and by calculating a rate-distortion cost (RD cost), an intra prediction direction mode having a smallest RD cost value is selected.

In addition, intra prediction in the H.264/AVC is coding by using information included in a picture. Each sample in a block in an intra frame is predicted by using spatially neighboring samples of a block previously coded.

However, the picture quality of an image predicted only with intra prediction directions determined according to the H.264 standard is low.

Accordingly, reducing the amount of residual information and increasing a coding efficiency by improving intra prediction directions used in a compression algorithm is needed.

### SUMMARY OF THE INVENTION

The present invention provides a method and apparatus for image intra prediction by which intra prediction is performed according to an intra prediction mode having arbitrary directivity, thereby improving the picture quality of a prediction image, and reducing the residual component being coded so as to increase a compression ratio.

The present invention also provides a method of determining an image intra prediction mode to enhance image intra prediction performance, by determining a new intra prediction mode which adaptively uses original intra blocks and new intra blocks.

According to an exemplary aspect of the present invention, there is provided a method of performing image intra prediction, the method including: calculating arbitrary edge directions and amplitudes of the edges based on neighboring pixels of a prediction block; from among the calculated edge directions, selecting a predetermined number of edge directions in order of the amplitude of the edges; and determining an intra prediction mode by performing block prediction in the selected edge direction.

According to another exemplary aspect of the present invention, there is provided a method of determining an intra prediction direction of an image, the method including: finding an area having a highest pattern continuity to a current block by using neighboring pixels of the current block; performing intra prediction in arbitrary prediction directions in the area; and determining an optimum prediction direction based on the rate-distortion cost of each of the prediction directions.

According to another exemplary aspect of the present invention, there is provided a method of determining an image intra prediction mode, the method including: finding an area having a highest pattern continuity to a current block, by using neighboring pixels of the current block; determining an optimum intra prediction direction by performing a first cost calculation of each of the arbitrary directions in the area; determining an optimum intra prediction direction by performing a second cost calculation of each intra prediction direction determined as a standard in the area; and determining a first intra prediction mode and a second intra prediction mode by comparing the first and second cost values.

According to another exemplary aspect of the present invention, there is provided an apparatus for performing image intra prediction including: a first calculation unit calculating a rate-distortion cost by performing encoding in a first intra prediction mode having a number of edge directions, the number being determined as a standard; a second calculation unit calculating a rate-distortion cost by performing encoding in a second intra prediction mode having a number of edge directions, the number being arbitrarily determined; and a third calculation unit for determining an intra prediction mode having a minimum rate-distortion cost.

### BRIEF DESCRIPTION OF THE DRAWINGS

The above and other features and advantages of the present invention will become more apparent by describing in detail exemplary embodiments with reference to the attached drawings in which:

FIGS. 1A and 1B are diagrams explaining an H.264/AVC intra prediction method;

FIG. 2 is a diagram explaining an intra prediction method for a 4×4 block, according to an exemplary embodiment of the present invention;

FIG. 3 is a block diagram of a moving picture encoding apparatus to which an image intra prediction apparatus according to an exemplary embodiment of the present invention is applied;

FIG. 4 is a flowchart illustrating a method of image intra prediction according to an exemplary embodiment of the present invention;

FIG. 5 is a flowchart illustrating a method of determining a first intra prediction mode and a second intra prediction mode according to an exemplary embodiment of the present invention;

FIG. 6 is a flowchart illustrating a method of determining a first intra prediction mode and a second intra prediction mode, according to another exemplary embodiment of the present invention;

FIGS. 7A and 7B are diagrams explaining a second intra prediction process, according to an exemplary embodiment of the present invention;

FIG. 8 is a flowchart illustrating an intra prediction decoding method of an image, according to an exemplary embodiment of the present invention;

FIG. 9 is a block diagram illustrating a moving picture decoding apparatus to which an intra prediction decoding method of an image, according to an exemplary embodiment of the present invention, is applied;

FIG. 10 illustrates the vertical direction prediction mode;

FIG. 11 illustrates the horizontal direction prediction mode;

FIG. 12 illustrates the DC direction prediction mode;

FIG. 13 illustrates the diagonal down-left prediction mode;

FIG. 14 illustrates the diagonal down-right prediction mode;

FIG. 15 illustrates the vertical-right prediction mode;

FIG. 16 illustrates the horizontal-down prediction mode;

FIG. 17 illustrates the vertical-left prediction mode;

FIG. 18 illustrates the horizontal-up prediction mode; and

FIG. 19 illustrates an image intra prediction apparatus according to an exemplary embodiment of the present invention.

### DETAILED DESCRIPTION OF EXEMPLARY EMBODIMENTS OF THE INVENTION

The present invention will now be described more fully with reference to the accompanying drawings, in which exemplary embodiments of the invention are shown.

An intra prediction process of H.264/Advanced video coding (AVC) is a method of prediction-coding a block in a frame by using information in the identical frame.

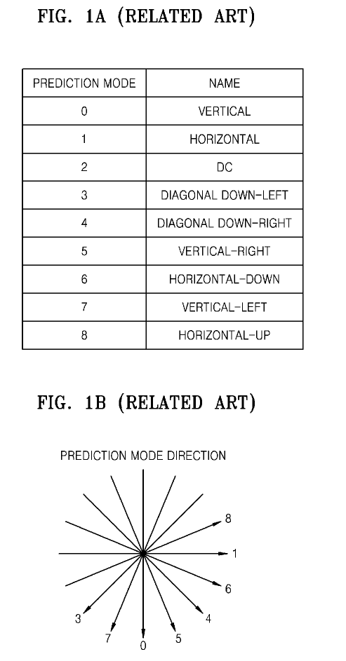

In relation to a luminance signal, there are four 16×16 prediction modes, nine 4×4 prediction modes and nine 8×8 prediction modes. In relation to a chrominance signal, there are four 8×8 prediction modes. Referring to FIGS. 1A and 1B, a first prediction method such as the H.264/AVC prediction method will now be explained.

FIG. 1A is a diagram explaining intra prediction modes of a 4×4 block.

Referring to FIG. 1A, the intra prediction of a 4×4 block has a vertical prediction mode (mode 0), a horizontal prediction mode (mode 1), a DC prediction mode (mode 2), a diagonal down-left prediction mode (mode 3), a diagonal down-right prediction mode (mode 4), a vertical-right prediction mode (mode 5), a horizontal-down prediction mode (mode 6), a vertical-left prediction mode (mode 7), and a horizontal-up prediction mode (mode 8).

FIG. 1B is a diagram illustrating 4×4 block prediction directions which are applied in intra prediction.

Referring to FIG. 1B, a number indicated by an arrow is a prediction mode value for which prediction is to be performed in the arrow direction.

In this case, mode 2 is the DC prediction mode having no directivity and thus is not indicated by an arrow.

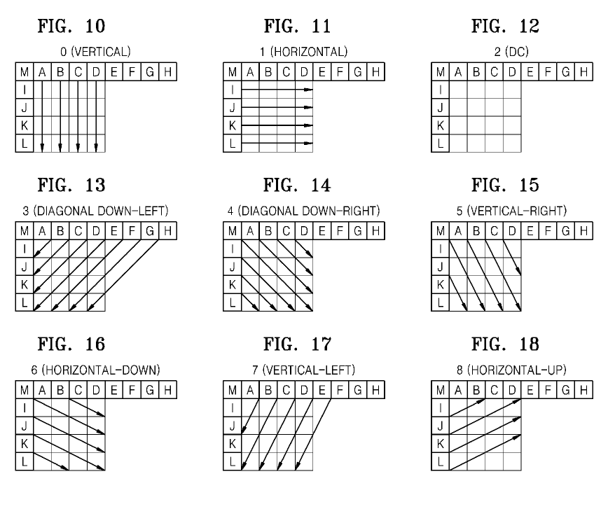

FIGS. 10-18 are diagrams illustrating an intra prediction for a 4×4 block.

In intra coding of the 4×4 block, a prediction block is generated by using neighboring pixels (A-M) of an object block, and a sum of absolute differences (SAD). A prediction mode having the smallest SAD is selected from the 9 prediction modes described above, as an optimum prediction mode.

In FIG. 10, mode 0 is the vertical direction prediction mode in which the value of each pixel included in the object block is predicted by projecting the top 4 pixels A, B, C, and D in the vertical direction.

In FIG. 11, mode 1 is the horizontal direction prediction mode.

In FIG. 12, mode 2 is the DC mode having no direction in which the mean value of 4 pixels of a block immediately to the left of the object block and 4 pixels of a block immediately above the object block, i.e., 8 pixels in total, is obtained, thereby predicting the 4×4 pixels of the object block.

In FIG. 13, mode 3 is the prediction mode in the diagonal down-left direction.

In FIG. 14, mode 4 is the prediction mode in the diagonal down-right direction.

In FIG. 15, mode 5 is the prediction mode in the vertical-right direction.

In FIG. 16, mode 6 is the prediction mode in the horizontal-down direction.

In FIG. 17, mode 7 is the prediction mode in the vertical-left direction.

In FIG. 18, mode 8 is the prediction mode in the horizontal-up direction.

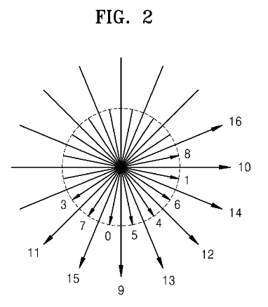

FIG. 2 is a diagram explaining a second intra prediction method for a 4×4 block, according to an exemplary embodiment of the present invention.

Referring to FIG. 2, the second intra prediction method of a 4×4 block adds arbitrary prediction directions between 4×4 block intra prediction directions of the described above first intra prediction method, indicated by a dotted line. For example, the second 4×4 intra prediction method has intra prediction modes having 16 directions including a DC prediction mode. The second 4×4 block intra prediction may add an arbitrary intra prediction direction, set by a user, between the 4×4 intra prediction directions of the first intra prediction method.

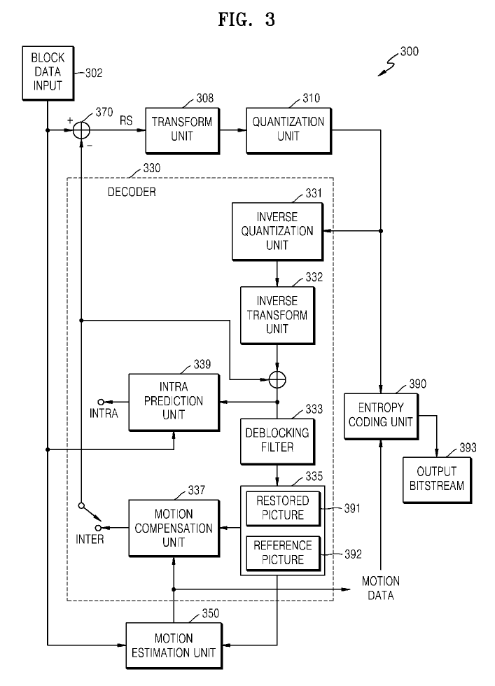

FIG. 3 is a block diagram of a moving picture encoding apparatus 300 to which an image intra prediction apparatus according to an exemplary embodiment of the present invention is applied.

Referring to FIG. 3, the moving picture encoding apparatus 300 includes a transform unit 308, a quantization unit 310, a moving picture decoder 330, a motion estimation unit 350, a subtraction unit 370, and an entropy coding unit 390.

The moving picture decoder 330, decodes a bitstream generated by the moving picture encoding apparatus 300, and includes the inverse quantization unit 331, the inverse transform unit 332, the deblocking filter unit 333, the picture restoration unit 335, the motion compensation unit 337, and the intra prediction unit 339.

The image data 302 is input to the moving picture encoding apparatus 300 in units of macroblocks formed each by 16×16 pixels.

The transform unit 308 transforms a residue, which is the difference value between a prediction image block and an original image block, according to a predetermined method. A leading transform technique includes discrete cosine transform (DCT).

The quantization unit 310 quantizes the residue transformed in the transform unit 308 according to the predetermined method.

The inverse quantization unit 331 inverse-quantizes the quantized residue information.

The inverse transform unit 332 inverse-transforms the inverse-quantized residue information to an original method.

The deblocking filter unit 333 receives an input of the inverse-transformed residue information from the inverse transform unit 332, and performs filtering of the residue information.

The picture restoration unit 335 receives an input of the filtered residue information from the deblocking filter unit 333 and restores an image in units of restored pictures 391. A picture may be an image of a frame unit or a field unit. Also, the picture restoration unit 335 may have a buffer capable of storing a plurality of pictures that are used as reference pictures provided to be used for motion estimation.

The motion estimation unit 350 receives at least one reference picture 392 stored in the picture restoration unit 335, performs motion estimation of an input macroblock, and outputs motion data including an index indicating a reference picture and a block mode.

According to the motion data input from the motion estimation unit 350, the motion compensation unit 337 extracts a macroblock, corresponding to the input macroblock, from the reference picture that is used for motion estimation.

If a prediction block that corresponds to a block to be currently encoded is formed by performing intra prediction, the subtraction unit 370 calculates the difference between a current block and the prediction block, thereby generating a residue signal RS.

The residue signal output from the subtraction unit 370 is transformed and quantized by the transform unit 308 and the quantization unit 310, respectively, and entropy-encoded by the entropy encoding unit 390. An output bitstream 393 is generated. Intra prediction information may be included in the header of the bitstream.

The intra prediction unit 339 calculates arbitrary edge directions and the amplitudes of the edge directions based on neighboring pixels of a prediction block; arranges the edge directions in an order according to the amplitudes of the edges; from the arranged edge directions, selects a number of edge directions; performs block prediction of each of the selected edge directions to determine an optimum intra prediction mode; and predicts a current block in the determined intra prediction mode.

The intra prediction unit 339 performs encoding with a first intra prediction method having a predetermined number of edge directions, where the predetermined number is set, for example, by the H.264 standard, and a second intra prediction method having an arbitrary number of edge directions, and calculates a rate-distortion cost (RD cost) for the modes of the first intra prediction method and the modes of the second intra prediction method, to determine an intra prediction mode having a smallest RD cost as an optimum intra prediction mode.

After the prediction mode is determined, the intra prediction unit 339 generates a prediction block according to the determined intra prediction mode, and obtains the difference between the prediction block and a block which is the object of the prediction, to calculate a differential block according to the determined prediction mode. Then, a 4×4 transform, quantization, inverse-quantization, and inverse-transform of the differential block are performed. The differential block obtained through this process is combined with the prediction block to reconstruct a 4×4 block. The reconstructed 4×4 block is used to predict a next 4×4 block.

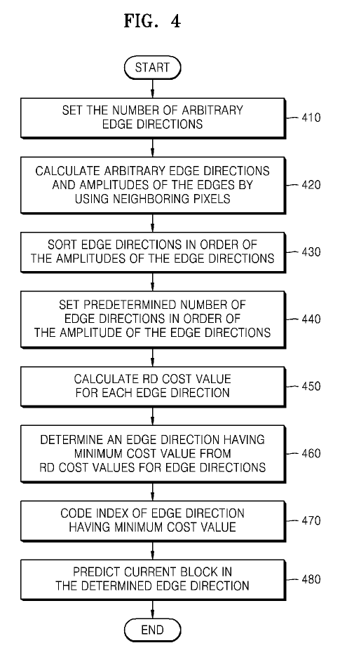

FIG. 4 is a flowchart illustrating a method of image intra prediction according to an exemplary embodiment of the present invention.

The number of arbitrary edge directions is set, in operation 410. For example, a number of the edge directions may be set to be greater than 9 edge directions of the H.264 standard, as illustrated in FIG. 2, such as, for example 16 edge directions.

The edge directions and amplitudes of neighboring pixels of the prediction block are calculated, in operation 420. For example, a Sobel operator, which is known in the art, is used to calculate the edge directions and amplitudes. For example, when Sobel operators are applied, a Sobel operator (Gx) in the horizontal direction and a Sobel operator (Gy) in the vertical direction are applied to each of the neighboring pixels of the prediction block, to detect the edge directions and amplitudes of neighboring pixels of the prediction block.

The Sobel operator (Gx) in the horizontal direction and the Sobel operator (Gy) in the vertical direction are Equations 1 and 2, and Sobel operations are performed in units of pixels:

$$\begin{matrix}{G}_{x} = [ \begin{matrix}1 & 0 & - 1 \\ 2 & 0 & - 2 \\ 1 & 0 & - 1\end{matrix} ] & ( 1 ) \\ {G}_{y} = [ \begin{matrix}- 1 & - 2 & - 1 \\ 0 & 0 & 0 \\ 1 & 2 & 1\end{matrix} ] & ( 2 )\end{matrix}$$

In the Sobel operation, a pixel value at the position matching with each coefficient of the Sobel operator (Gx) in the horizontal direction is multiplied by the coefficient in a one-to-one corresponding relationship. All products are added to obtain a value (K1). A pixel value at the position matching with each coefficient of the Sobel operator (Gy) in the vertical direction is multiplied by the coefficient in a one-to-one corresponding relationship. All products are added to obtain a value (K2). Accordingly, by using the values (K1) and (K2), the edge amplitudes (K) and edge directions (θ) of the neighboring pixels are detected according to Equations 3 and 4:

$$\begin{matrix}K = \sqrt{K {1}^{2} + K {2}^{2}} & ( 3 ) \\ θ = {tan}^{- 1} ( \frac{K 2}{K 1} ) & ( 4 )\end{matrix}$$

The edge directions (θ) of the neighboring pixels detected by the Sobel operators are mapped to the selected arbitrary 16 intra prediction directions illustrated in FIG. 2. The intra prediction directions remaining without being mapped to the respective edge directions of the neighboring pixels may be initialized.

The 16 edge directions are sorted in the order of the amplitudes of the edges, in operation 430. For example, the 16 edge directions are stored in a buffer in the order of the amplitudes of the edges.

A predetermined number of edge directions, such as 9 edge directions, is selected from the 16 edge directions in the order of the amplitudes of the edges, for example, to comply with the number of edge directions set in the H.264 standard, in operation 440.

The block prediction of each of the selected 9 edge directions is performed. The RD cost between the prediction block and the original block is calculated, in operation 450.

For example, the RD cost is a function value indicating the accuracy of the prediction coding and the magnitude of the amount of occurred bits. Examples of a function for measuring the RD cost include a sum of absolute differences (SAD), a sum of absolute transformed differences (SATD), a sum of squared differences (SSD), and a mean of absolute differences (MAD), but the function is not limited to these. Among the functions for measuring the cost described above, for example, the RD cost obtained by using the SAD function is a value obtained by adding up the absolute values of the differences between the prediction values of respective pixels and the actual pixel values in a macroblock.

An edge direction having a smallest RD cost value from the calculated RD cost values for respective edge directions is determined, in operation 460.

The index of the edge direction having the minimum RD cost value is coded, in operation 470.

Intra prediction of the current block is performed by using the determined edge direction, in operation 480.

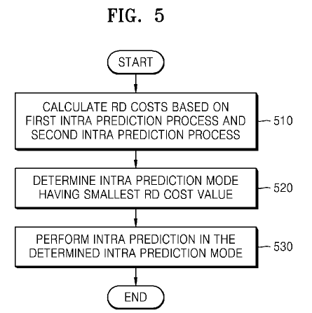

FIG. 5 is a flowchart illustrating a method of determining a first intra prediction mode and a second intra prediction mode according to an exemplary embodiment of the present invention.

The RD costs based on the first intra prediction process and the second intra prediction process are calculated, in operation 510.

For example, block prediction is performed in each of the 9 edge directions set according to the H.264 standard, and the RD cost value between the prediction block and the original block is calculated to determine the first intra prediction mode as a mode having a minimum RD cost value. The block prediction is performed in each of the arbitrarily determined edge directions, to which the second intra prediction method is applied. The RD cost value between the prediction block and the original block is calculated to determine the second intra prediction mode as a mode having a minimum RD cost value.

By comparing a minimum RD cost value of the first intra prediction mode with a minimum RD cost value of the second intra prediction mode, an intra prediction mode having the smallest RD cost value is determined, in operation 520.

By using the determined intra prediction mode, intra prediction of the current block is performed, in operation 530.

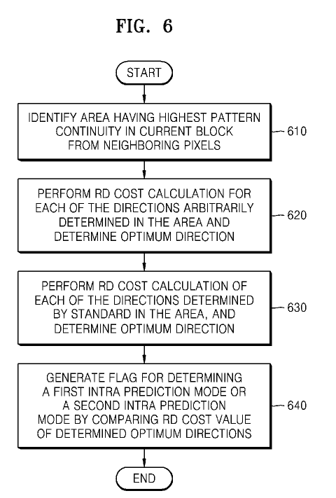

FIG. 6 is a flowchart illustrating a method of determining a first intra prediction mode and a second intra prediction mode according to another exemplary embodiment of the present invention.

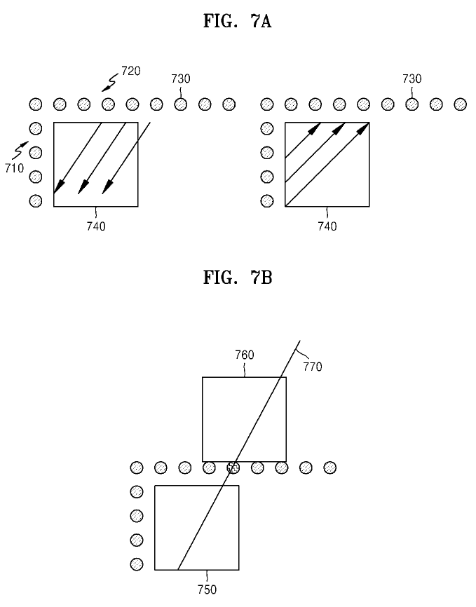

First, by dividing 180 degrees by 5 degrees, 36 intra prediction directions are set. As illustrated in FIG. 7A, context pixels to the left 710 or above 720 of a block are selected for block prediction. A dot 730 indicates an already coded pixel in the neighboring block. A square 740 indicates a block which is an object of coding.

As illustrated in FIG. 7B, by using neighboring pixels of the current block 750, an area 760 having the highest edge pattern continuity with respect to the current block 750 is identified, in operation 610. Here, a line 770 indicates an arbitrary edge pattern.

The best direction prediction in the identified area is identified. As illustrated in FIG. 7B, intra prediction is performed in each of the determined 36 intra prediction directions in the identified area 760. The RD cost value between the prediction block and the original block is calculated. A prediction direction, having the smallest RD cost value, from the 36 directions is determined as an optimum prediction direction, in operation 620.

The RD cost value between the prediction block and the original block is calculated by performing the intra prediction in each of 9 prediction directions, which are determined as the H.264 standard in the identified area. For example, a prediction direction having the smallest RD cost value from the 9 directions is determined as an optimum prediction direction, in operation 630.

A 1-bit flag, for determining a first intra prediction mode or a second intra prediction mode based on comparing the RD cost values of the determined optimum intra prediction directions, is set in units of 4×4 blocks, in operation 640.

Accordingly, in a 4×4 block, to which the first intra prediction process based on the established standard is applied, one direction estimated from the 9 prediction directions is predicted. In a 4×4 block, to which the second intra prediction process based on the arbitrarily set intra prediction directions is applied, one direction estimated among 36 directions is predicted.

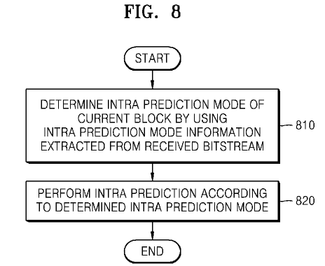

FIG. 8 is a flowchart illustrating an intra prediction decoding method of an image, according to an exemplary embodiment of the present invention.

A bitstream encoded according to the second intra prediction encoding process, described above, is received. The header of the bitstream includes information relating to the second intra prediction process.

By using the intra prediction mode information in the header of the bitstream, an intra prediction mode of a current input block to be decoded is determined, in operation 810.

According to the determined intra prediction mode, intra prediction is performed, thereby generating a prediction block corresponding to the current block. By adding the prediction block and a residue value included in the bitstream, the current block is restored, in operation 820.

The intra prediction will now be explained in more detail.

Based on pixels neighboring the block to be decoded, arbitrary edge directions and the amplitudes of the edges are calculated.

According to the amplitudes of the edges, the edge directions are arranged in order.

From the arranged edge directions, 9 edge directions are selected in the order of the amplitudes of the edges.

Each block prediction is performed in the prediction direction corresponding to a decoded index.

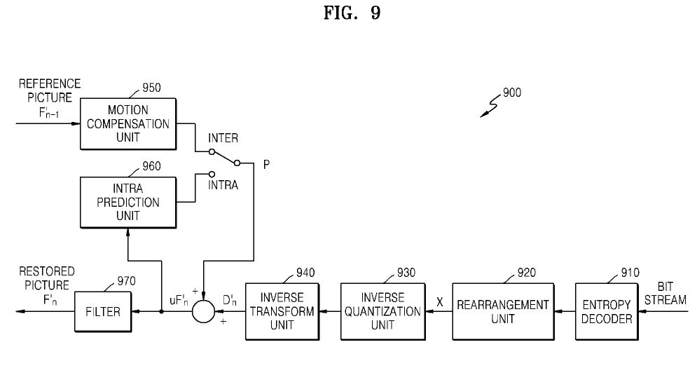

FIG. 9 is a block diagram illustrating a moving picture decoding apparatus 900 to which an intra prediction decoding method of an image, according to an exemplary embodiment of the present invention, is applied.

Referring to FIG. 9, the moving picture decoding apparatus 900 includes an entropy decoder 910, a rearrangement unit 920, an inverse quantization unit 930, an inverse transform unit 940, a motion compensation unit 950, an intra prediction unit 960, and a filter 970.

Through the entropy decoder 910 and the rearrangement unit 920, a compressed bitstream is received and entropy-decoded to extract intra prediction mode information and quantized coefficient information.

The inverse quantization unit 930 and the inverse transform unit 940, respectively, perform inverse quantization and inverse transform of the extracted intra prediction mode information and quantized coefficients to extract transform coefficients, motion vector information, header information, and intra prediction mode information.

Each of the motion compensation unit 950 and the intra prediction unit 960 generates a prediction block according to a decoded picture type by using the decoded header information. For example, the prediction block (P) and an error value (D′n) are added and a result (uF′n) is generated, from which a blocking effect is removed through the filter 970. A restored picture (F′n) is thus generated.

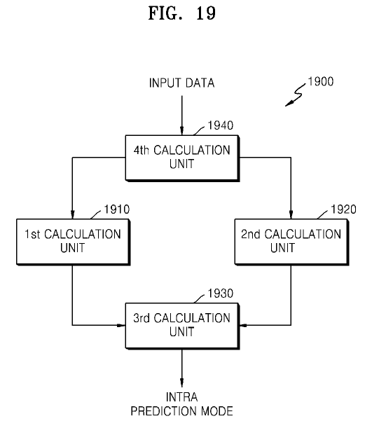

Referring to FIG. 19, an apparatus 1900 performs an image intra prediction. A first calculation unit 1910 calculates a first rate-distortion cost by performing encoding based on a first intra prediction process having a standard number of edge directions predetermined. A second calculation unit 1920 calculates a second rate-distortion cost by performing encoding based on a second intra prediction process having an arbitrarily determined number of edge directions set. A third calculation unit 1930 determines an intra prediction mode having a minimum rate-distortion cost based on calculations of the first and the second rate-distortion costs.

A fourth calculation unit 1940 calculates arbitrary edge directions and amplitudes of the edges based on neighboring pixels of a prediction block, arranges the edge directions in an order of the amplitudes of the edges, and selects a number of intra prediction directions from the arranged edge directions.

The third calculation unit 1930 performs block prediction in each selected intra prediction to determine the intra prediction mode.

According to exemplary embodiments of the present invention, intra prediction of an image is performed according to an intra prediction mode having arbitrary directivity, thereby improving the picture quality of a prediction image and reducing a residual component being coded such that the compression ratio may be increased.

Also, by adaptively using original intra blocks and new intra blocks, the performance of intra prediction of an image may be enhanced.

The exemplary embodiments may also be embodied as computer-readable codes on a computer-readable recording medium. The computer-readable recording medium may be any data storage device that may store data which can be thereafter read by a computer system. Examples of the computer-readable recording medium include read-only memory (ROM), random-access memory (RAM), CD-ROMs, magnetic tapes, floppy disks, and optical data storage devices. The computer-readable recording medium can also be distributed over network coupled computer systems so that the computer-readable code is stored and executed in a distributed fashion.

The exemplary embodiments may also be embodied as computer-readable codes or instructions on a transmission medium. Examples of the transmission medium include carrier waves and other data transmission devices which can carry data over the Internet.

While the present invention has been particularly shown and described with reference to exemplary embodiments thereof, it will be understood by one of ordinary skill in the art that various changes in form and details may be made therein without departing from the spirit and scope of the present invention as defined by the following claims. The exemplary embodiments should be considered in descriptive sense only and not for purposes of limitation. Therefore, the scope of the invention is defined not by the detailed description of the invention but by the appended claims, and all differences within the scope will be construed as being included in the present invention.

What is claimed is:

1. A method of performing image intra prediction, the method comprising:
calculating arbitrary edge directions and amplitudes of edges based on neighboring pixels of a prediction block;
selecting a number of intra prediction directions in an order of the amplitudes of the edges from the calculated edge directions; and
determining an intra prediction mode by performing block prediction in the selected intra prediction directions.

2. The method of claim 1, wherein the calculating comprises:
setting a number of the arbitrary edge directions in advance.

3. The method of claim 1, wherein the calculating comprises detecting the edge directions and the amplitudes of the edges of each neighboring pixel of the prediction block, the method further comprising:
mapping the detected edge directions to the selected intra prediction directions, wherein the number of the intra prediction directions is set to an arbitrary number.

4. The method of claim 1, wherein the selecting comprises:
arranging the calculated edge directions in the order of the amplitudes of the edges; and
selecting the number of the intra prediction directions from the arranged edge directions in the order of the amplitudes of the edges.

5. The method of claim 1, wherein the selecting comprises:
selecting the number of the intra prediction directions to be equal to a predetermined standard.

6. The method of claim 1, wherein the determining the intra prediction mode comprises:
calculating a rate-distortion cost of each selected intra prediction direction by performing encoding of a prediction block in each selected intra prediction direction; and
determining an intra prediction direction having a minimum rate-distortion cost value from the calculated rate-distortion cost values of the selected intra prediction directions.

7. The method of claim 1, further comprising:
coding an index corresponding to the determined intra prediction mode.

8. A method of determining an intra prediction direction of an image, the method comprising:
identifying an area having a highest pattern continuity to a current block by using neighboring pixels of the current block;
performing intra prediction in arbitrary prediction directions in the identified area; and
determining an optimum prediction direction based on a rate-distortion cost of each prediction direction.

9. A method of performing optimum image intra prediction, the method comprising:
performing encoding of each image block based on a first intra prediction process, having a number of edge directions established by a standard;
performing encoding of each image block based on a second intra prediction process, in which an arbitrary number of edge directions is set;
calculating a rate-distortion cost related to each of the first and second intra prediction processes;
determining an intra prediction mode having a minimum rate-distortion cost based on calculating; and
performing image intra prediction of the image blocks in units of blocks according to the determined intra prediction mode.

10. The method of claim 9, wherein the calculating the rate-distortion cost comprises:
determining an edge direction having a smallest rate-distortion cost value by performing cost calculation of each edge direction established by the standard; and
determining an edge direction having a smallest rate-distortion cost value by performing cost calculation of each arbitrary edge direction.

11. A method of determining an image intra prediction mode, the method comprising:
identifying an area having a highest pattern continuity to a current block by using neighboring pixels of the current block;
determining a first intra prediction direction by performing a first cost calculation of each arbitrarily set direction in the identified area;
determining a second intra prediction direction by performing a second cost calculation of each intra prediction direction determined by a standard in the identified area; and
determining one of a first intra prediction mode and a second intra prediction mode by comparing the first and second cost calculations.

12. The method of claim 11, further comprising:
setting a flag for determining one of the first intra prediction mode and the second intra prediction mode for each block unit.

13. An apparatus for performing image intra prediction comprising:
a first calculation unit which calculates a first rate-distortion cost by performing encoding based on a first intra prediction process, having a number of edge directions established by a standard;
a second calculation unit which calculates a second rate-distortion cost by performing encoding based on a second intra prediction process, in which an arbitrarily determined number of edge directions is set; and
a third calculation unit which determines an intra prediction mode having a minimum rate-distortion cost based on calculations of the first and the second rate-distortion costs.

14. The apparatus of claim 13, further comprising:
a fourth calculation unit which:
calculates arbitrary edge directions and amplitudes of the edges based on neighboring pixels of a prediction block,
arranges the edge directions in an order of the amplitudes of the edges, and
selects a number of intra prediction directions from the arranged edge directions.

15. The apparatus of claim 14, wherein the third calculation unit performs block prediction in each selected intra prediction direction to determine the intra prediction mode.
